(19) United States
(12) Patent Application Publication
(10) Pub. No.: US 2019/0100409 A1
(43) Pub. Date: Apr. 4, 2019

(54) ELEVATOR PRESSURIZATION

(71) Applicant: Otis Elevator Company, Farmington, CT (US)

(72) Inventor: Richard N. Fargo, Plainville, CT (US)

(21) Appl. No.: 15/528,656

(22) PCT Filed: Nov. 18, 2015
(86) PCT No.: PCT/US2015/061236

§ 371 Date: May 22, 2017

Related U.S. Application Data
(60) Provisional application No. 62/083,600, filed on Nov. 24, 2014.

(51) Int. Cl. B66B 11/02

(52) U.S. Cl. CPC B66B 11/024

(57) ABSTRACT

A method of pressurizing an elevator (112) includes pressurizing a lobby (102) to a pressure (P2) different from ambient pressure (P1) at the elevation of the lobby (102). Pressurizing the lobby (102) can generally include pressurizing the lobby (102) to a pressure (P2) between the ambient pressure (P1) at the elevation of the lobby (102) and an ambient pressure (P6) at a destination elevation. This can allow for at least some equalization of the inner ears of passengers to take place while passengers are waiting to pass from the lobby (102) into the elevator cab (112), or waiting to pass from the lobby (102) into the ambient pressure (P1) of the building outside the lobby (102).

### CROSS-REFERENCE TO RELATED APPLICATIONS

This application claims the benefit of and priority to U.S. Provisional Patent Application No. 62/083,600, filed Nov. 24, 2014. The entire application is incorporated herein by reference in its entirety.

### BACKGROUND OF THE INVENTION

### 1. Field of the Invention

The present disclosure relates to elevators, and more particularly to elevator pressurization.

### 2. Description of Related Art

Atmospheric air pressure varies with elevation. The human ear is sensitive to air pressure due to the need to equalize pressure across the tympanic membrane. Changes in elevation can cause discomfort if the change in elevation is more rapid than the inner ear can equalize with the ambient pressure.

In elevator systems, the discomfort caused to the human ear can be a limiting factor on elevator speed. While these effects can potentially exist in any elevator system, they are a prominent factor for elevators spanning heights on the order of 300 meters or more. It is typical for the inner ear to be particularly sensitive when descending in an elevator, so it is not uncommon for descent speeds to be slower than ascent speeds in elevators for super high rise buildings. The ascent and descent speeds of elevator cabs are typically limited to avoid causing discomfort to passengers, and the descent speeds in particular are limited, even though higher speeds are mechanically feasible.

Some solutions for these limitations have been used to increase elevator speeds without causing inner ear discomfort. For example, it is possible to seal and pressurize an elevator cab. By controlling the pressure within the cab during ascent and descent, some of the rapid changes in pressure can be mitigated. This allows for faster elevator movement. However, even these measures have limitations on how much travel time can be reduced without causing inner ear discomfort.

There is still a need in the art for improved elevator pressurization. The present disclosure provides a solution for this need.

### SUMMARY OF THE INVENTION

A method of pressurizing an elevator cab includes pressurizing a lobby to a pressure different from ambient pressure at the elevation of the lobby. For example, the lobby can be a ground level lobby pressurized to a pressure lower than the ambient pressure at ground level. It is also contemplated that the lobby can be an upper level lobby, for example a top floor lobby in a super high rise building, that is pressurized to a pressure higher than ambient pressure at the elevation of the upper level lobby. The method also includes opening fluid communication between the lobby and an elevator cab, for example by coordinated opening of the elevator and hoistway doors upon arrival of the elevator cab at the lobby.

Pressurizing the lobby can generally include pressurizing the lobby to a pressure between the ambient pressure at the elevation of the lobby and an ambient pressure at a destination elevation. This can allow for at least some equalization of the inner ears of passengers to take place while passengers are waiting to pass from the lobby into the elevator cab, or waiting to pass from the lobby into the ambient pressure of the building outside the lobby. This extra equalization time outside the elevator cab can allow the elevator cab to travel at speeds in excess of speeds in traditional systems that rely solely on pressurization in the elevator cab for inner ear equalization.

In another aspect, the method includes sealing the elevator cab from the lobby, e.g., when the elevator cab departs from the lobby, and pressurizing the elevator cab to a pressure between that of the lobby and the ambient pressure at the destination elevation. In this manner, the pressurized elevator cab provides time for inner ear equalization in addition to the time provided in the pressurized lobby. This can provide for ascent and descent rates of 10 meters per second or more.

The method can also include pressurizing a destination lobby at the destination elevation to a pressure between that of the elevator cab and ambient pressure at the destination elevation, moving the elevator cab to the destination elevation, and opening fluid communication between the elevator cab and the destination lobby. In this manner, the pressurization of the original lobby, of the elevator cab, and of the destination lobby can all provide time for inner ear equalization, while the elevator cab moves between floors at only a fraction of the time required for inner ear equalization.

An elevator pressurization system includes a pressurized lobby sealed from ambient atmospheric pressure, as described above. A hoistway is connected to the pressurized lobby by a hoistway door. It is contemplated that an elevator cab can be supported within the hoistway, wherein the hoistway is in fluid communication with ambient pressure. The elevator cab can include an elevator cab door which in a closed position seals the elevator cab from ambient pressure, wherein the elevator cab door is configured to cooperate with the hoistway doors to provide access between the pressurized lobbies and the elevator cab.

A pressure controller can be operatively connected to control a pressurizer that is in fluid communication with the pressurized lobby, wherein the pressure controller and pressurizer are configured to regulate pressure within the pressurized lobby, to provide for at least some inner ear equalization to take place in the lobby as described above. The pressurized lobby can include a sealed building access door spaced apart from the hoistway door that provides access to and from the pressurized lobby. For example, the sealed building access door can be a revolving door that provides access between the pressurized lobby and the portion of a building that is at ambient pressure, wherein the revolving door subjects passengers to a specified change in pressure which is not uncomfortable, but enables inner ear equalization to begin while waiting for an elevator to arrive.

In addition to a main lobby that is pressure sealed, e.g., at the main entrance to a building, one or more upper lobbies can be included, each at a unique elevation above that of the main lobby. Each upper lobby can be pressure sealed and can be connected to the hoistway by a respective hoistway door. The elevator cab can move among the main lobby and the upper lobbies. One or more non-pressurized lobbies can be connected to the hoistway by respective hoistway doors at elevations between the elevation of the main lobby and the elevation of the lowest one of the upper lobbies.

A pressure controller as described above can be operatively connected to a respective pressurizer in fluid communication with each respective upper lobby. It is also contemplated that the system can include one or more pressurized lower lobbies below the elevation of the main lobby, wherein the lower lobbies are pressurized to respective pressures between that of the ambient pressure at the main lobby and the respective ambient pressure at the respective lower level.

The elevator cab can include a pressurizer in fluid communication with the elevator cab for pressurization of the elevator cab. The pressurizer of the elevator cab can be operatively connected to a pressure controller configured to regulate pressure of the elevator cab as it moves within the hoistway. A respective seal can be operatively connected to the hoistway to seal between the hoistway and each of the respective pressurized lobbies and elevator cab.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic elevation view of an exemplary embodiment of an elevator pressurization system constructed in accordance with the present disclosure, showing a passenger in a building at the ground floor in ambient pressure;

FIG. 2 is a schematic elevation view of the elevator pressurization system of FIG. 1, showing the passenger in the main lobby;

FIG. 3 is a schematic elevation view of the elevator pressurization system of FIG. 1, showing the passenger in the elevator cab at the main lobby elevation;

FIG. 4 is a schematic elevation view of the elevator pressurization system of FIG. 1, showing the passenger in the elevator cab as it moves within the hoistway;

FIG. 5 is a schematic elevation view of the elevator pressurization system of FIG. 1, showing the passenger in the elevator cab at an upper lobby elevation;

FIG. 6 is a schematic elevation view of the elevator pressurization system of FIG. 1, showing the passenger in the upper lobby; and

FIG. 7 is a schematic elevation view of the elevator pressurization system of FIG. 1, showing the passenger on the upper level floor in ambient pressure.

### DETAILED DESCRIPTION OF THE PREFERRED EMBODIMENTS

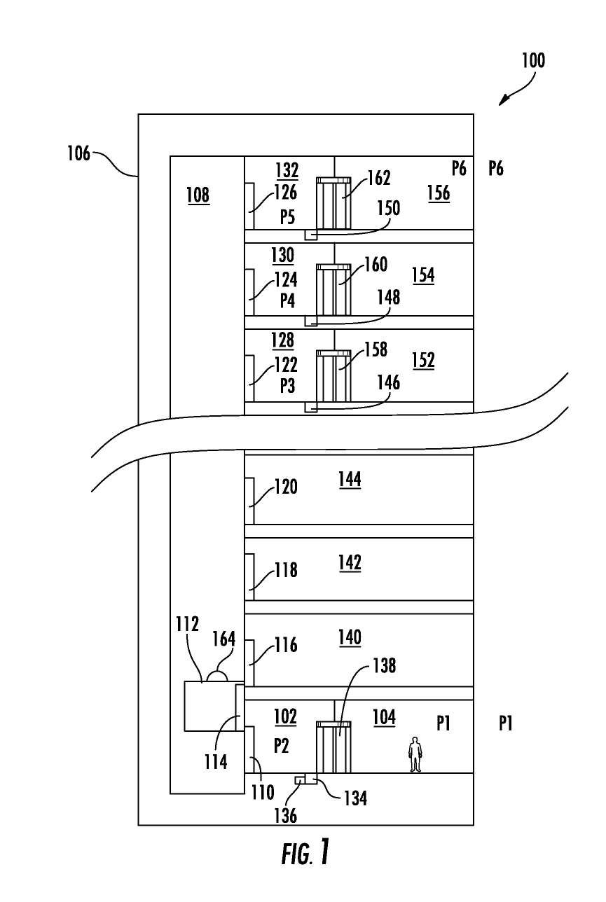

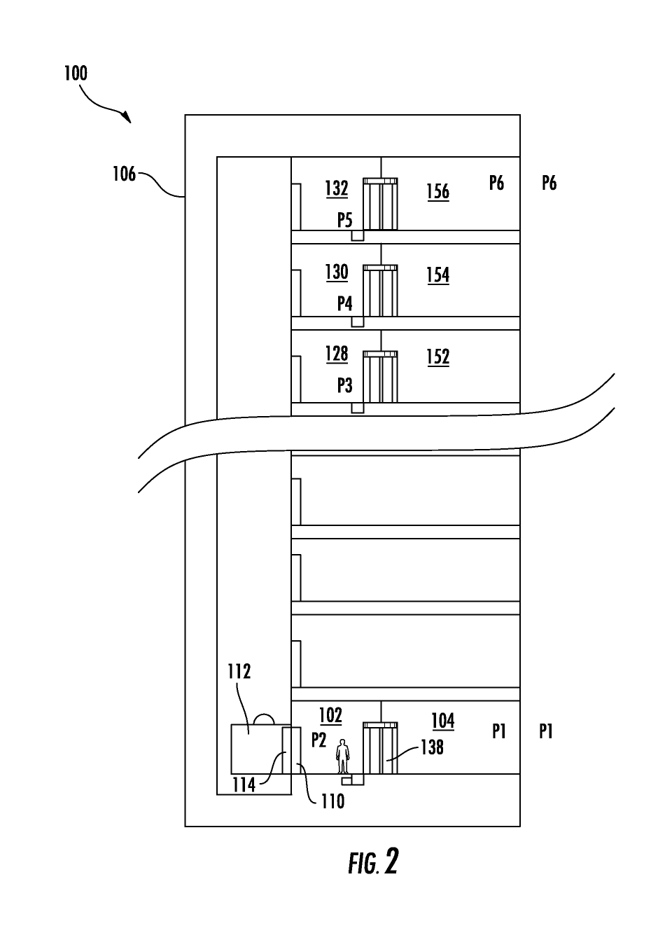

Reference will now be made to the drawings wherein like reference numerals identify similar structural features or aspects of the subject disclosure. For purposes of explanation and illustration, and not limitation, a partial view of an exemplary embodiment of a system in accordance with the disclosure is shown in FIG. 1 and is designated generally by reference character 100. Other embodiments of systems in accordance with the disclosure, or aspects thereof, are provided in FIGS. 2-7, as will be described. The systems and methods described herein can be used to improve elevator passenger inner ear comfort and to increase elevator cab speeds.

Elevator pressurization system 100 includes a pressurized lobby 102 sealed from ambient atmospheric pressure at the main floor 104 of a building 106. A hoistway 108 of building 106 is connected to pressurized lobby 102 by a hoistway door 110. Elevator cab 112 is supported within hoistway 108. Hoistway 108 can therefore be in fluid communication with ambient pressure. Elevator cab 112 includes an elevator cab door 114 which in a closed position seals the elevator cab 112 from ambient pressure, as shown in FIG. 1. Elevator cab door 114 is configured to cooperate with the hoistway doors 110, 116, 118, 120, 122, 124, and 126 to provide access between elevator cab 112 and the respective lobbies.

A pressure controller 136 is operatively connected to control a pressurizer 134 that is in fluid communication with pressurized lobby 102. Pressure controller 136 can include any suitable open or closed control loop so that together with pressurizer 134, pressure controller 136 can regulate pressure within the pressurized lobby 102 to provide for at least some inner ear equalization to take place in pressurized lobby 102.

Pressurized lobby 102 includes a sealed building access door 138 spaced apart from hoistway door 110 that provides access between main floor 104 and pressurized lobby 102 for passengers moving to and from the pressurized lobby 102. For example, the sealed building access door 138 can be a revolving door that provides access between pressurized lobby 102 and the portion of building 106 that is at ambient pressure. The revolving door subjects passengers to a specified change in pressure which is not uncomfortable, but enables inner ear equalization to begin while waiting for an elevator to arrive. Those skilled in the art will readily appreciate that any other suitable type of door or air lock can also be used in addition to or in lieu of a revolving door.

In addition to a pressurized lobby, which is a main lobby that is pressure sealed, e.g., at the main entrance to building 106, a plurality of upper lobbies 128, 130, and 134 are included, each at a unique elevation above that of the main lobby. Each of the upper lobbies 128, 130, and 134 is pressure sealed, and is connected to hoistway 108 by a respective hoistway door 122, 124, or 126. Each upper lobby 128, 130, and 134 connects to a respective upper floor 152, 154, and 156 by way of a respective building access door 158, 160, and 162 as described above with respect to building access door 138. Elevator cab 112 can move among the main pressurized lobby 102 and the upper lobbies 122, 124, and 126.

One or more non-pressurized lobbies, e.g., non-pressurized lobbies 140, 142, and 144, can be connected to the hoistway by respective hoistway doors, e.g., doors 116, 118, and 120, at elevations between the elevation of the main pressurized lobby 102 and the elevation of the lowest one of the upper lobbies. For example, in embodiments where building 106 is a super high rise, only the main lobby and upper lobbies above a height of 200 meters need be pressurized lobbies, and any lobbies between the main lobby and the upper pressurized lobbies need not necessarily be pressurized.

A pressure controller, e.g., pressure controller 136, can be operatively connected to a respective pressurizer 146, 148, and 150 in fluid communication with each respective upper lobby 128, 130, and 132. This provides a regulated pressure for each of the pressurized upper lobbies 128, 130, and 132 that is higher than the ambient pressure at each respective elevation.

Although shown an described in the exemplary context of having the main lobby on the ground floor, and all of the pressurized lobbies at the top of building 106, those skilled in the art having the benefit of this disclosure will readily appreciate that the systems and methods disclosed herein can be adapted to buildings with subterranean levels, including subterranean elevators with enough change in elevation to benefit from pressurized lobbies below the ground level lobby. The lower lobbies can be pressurized to respective pressures between that of the ambient pressure at the main lobby and the ambient pressure at the respective lower level. Moreover, while shown in the exemplary context of a building with three upper lobbies that are pressurized, and three non-pressurized lobbies, any suitable number of pressurized lobbies and non-pressurized lobbies can be used. The curved lines in FIG. 1 indicate that the middle portion of building 106 is not shown, but that any suitable number of floors can be included without departing from the scope of this disclosure.

With continued reference to FIG. 1, elevator cab 112 includes a pressurizer 164 in fluid communication with elevator cab 112 for pressurization of elevator cab 112. Pressurizer 164 of elevator cab 112 is operatively connected to a pressure controller, e.g., pressure controller 136, that is configured to regulate the pressure of elevator cab 112 as it moves within hoistway 108.

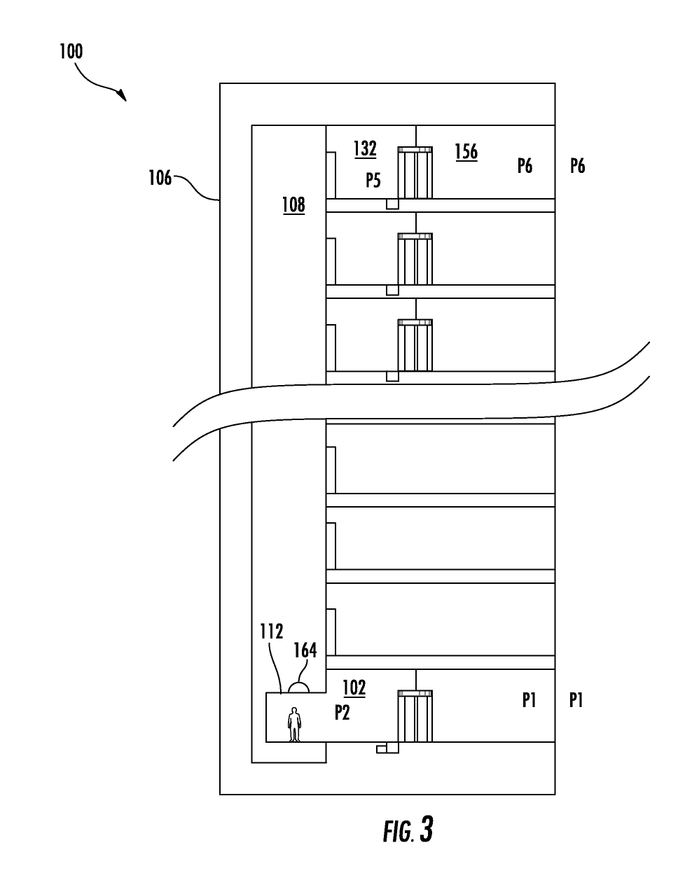

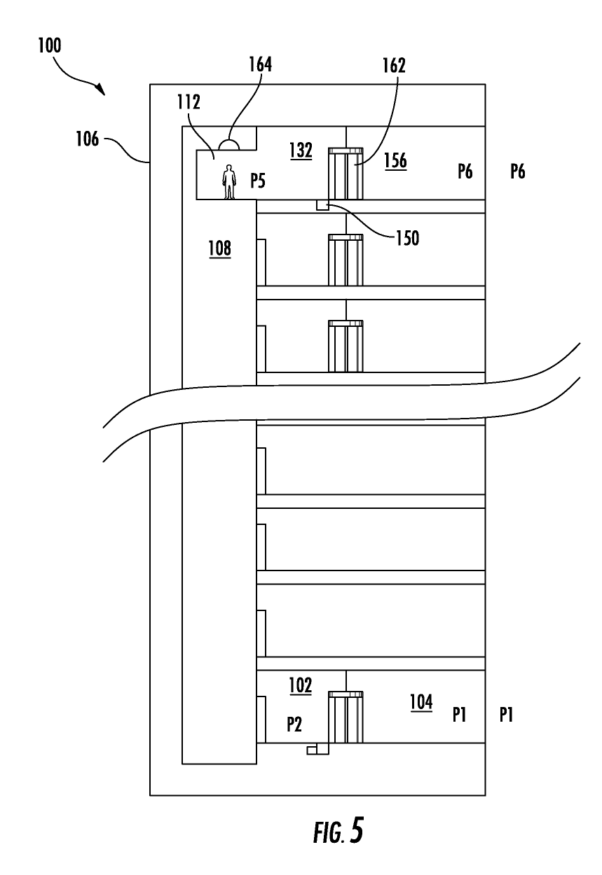

A method of pressurizing an elevator includes pressurizing a lobby to a pressure different from ambient pressure at the elevation of the lobby. For example, the lobby can be a ground level lobby, such as pressurized lobby 102, that is pressurized to a pressure lower than the ambient pressure at ground level. It is also contemplated that the lobby can be an upper level lobby, for example a top floor lobby such as upper lobby 132 in a super high rise building, that is pressurized to a pressure higher than ambient pressure at the elevation of the upper level lobby. The method also includes opening fluid communication between the lobby and an elevator cab, for example by coordinated opening of the elevator and hoistway doors upon arrival of the elevator cab at the lobby as shown in FIGS. 3 and 5. When opening fluid communication between the lobby and the elevator car, a seal can be used for sealing between the elevator car and the lobby to manage air leakage between the hoistway and the car or lobby. This seal device is engaged when the elevator car reaches the lobby level. More specifically, this seal can be permanently attached at the lobby, e.g. as part of the each of the hoistway doors 110, 122, 124, and 126, and can be extended to seal the elevator car once the elevator car arrives. It is also contemplated that the reverse could also work, i.e., the seal can be permanently attached to the elevator car, e.g., as part of elevator car door 114, but is will be understood that this configuration adds weight to the elevator car.

Pressurizing the lobby can generally include pressurizing the lobby to a pressure between the ambient pressure at the elevation of the lobby and an ambient pressure at a destination elevation. This can allow for at least some equalization of the inner ears of passengers to take place while passengers are waiting to pass from the lobby into the elevator cab, or waiting in or passing through the lobby into the ambient pressure of the building outside the lobby. This extra equalization time can allow the elevator cab, e.g., elevator cab 112, to travel at speeds in excess of speeds in traditional systems that rely solely on pressurization in the elevator cab for inner ear equalization.

In another aspect, the method includes sealing the elevator cab from the lobby, e.g., when the elevator cab departs from the lobby, and pressurizing the elevator cab to a pressure between that of the lobby and the ambient pressure at the destination elevation. In this manner, the pressurized elevator cab provides time for inner ear equalization in addition to the time provided in the pressurized lobby. This can provide for ascent and descent rates of 10 meters per second or more. Those skilled in the art will readily appreciate that there can optionally be some pressure differential still present between the elevator cab and the lobby until the doors open for fluid communication between the elevator cab and the lobby.

The method can also include pressurizing a destination lobby at the destination elevation to a pressure between that of the elevator cab and ambient pressure at the destination elevation, moving the elevator cab to the destination elevation, and opening fluid communication between the elevator cab and the destination lobby, e.g., as shown in FIGS. 3 and 5. In this manner, the pressurization of the original lobby, of the elevator cab, and of the destination lobby can all provide time for inner ear equalization, while the elevator cab moves between floors in only a fraction of the time required for inner ear equalization given the altitude traveled.

With reference to FIG. 1, a passenger is shown standing in the non-pressurized main floor 104, exposed to the ambient pressure P1 of the main floor. The pressure P1 is considerably higher than the ambient pressure P6 at the top of building 106 due to hydrostatic pressure, wind shear, and the like. The passenger passes through door 138 into pressurized lobby 102, as shown in FIG. 2. While passing through door 138, the passenger is brought to the pressure P2, which is lower than P1, but higher than P3, P4, P5, and P6, which are each indicated in FIG. 1 and are discussed in turn below. Passing through pressurized lobby 102 before boarding elevator cab 112 gives the passenger's ears a head start on equalization compared to traditional systems.

With reference now to FIG. 3, when elevator cab 112 arrives at pressurized lobby 102, elevator cab door 114 and hoistway door 110 open and the passenger boards elevator cab 112, which is initially pressurized at pressure P2.

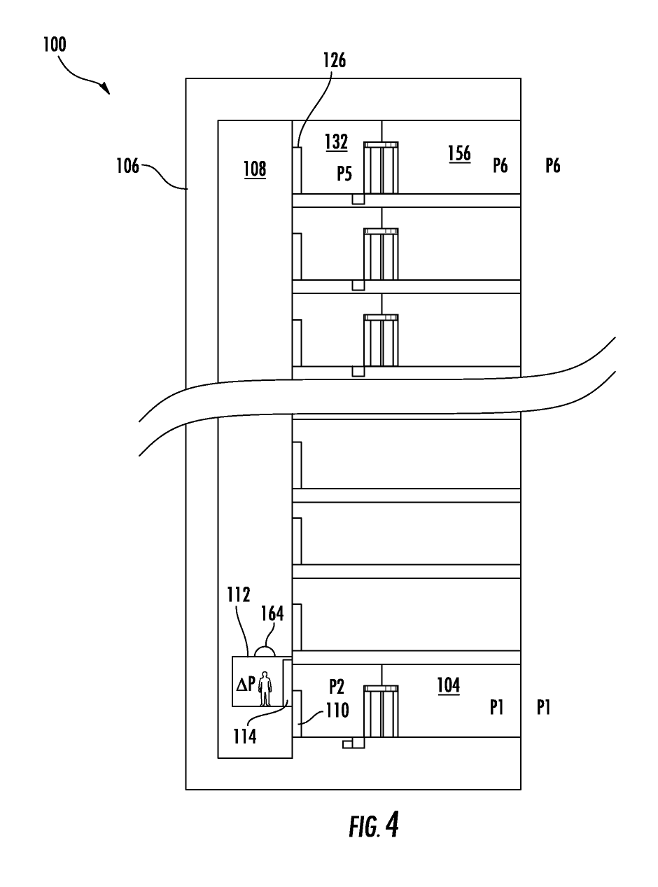

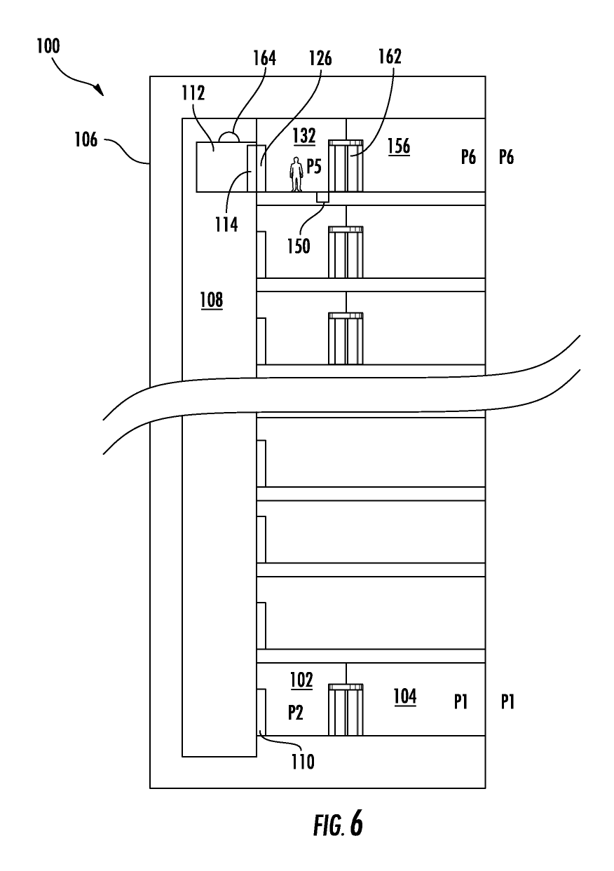

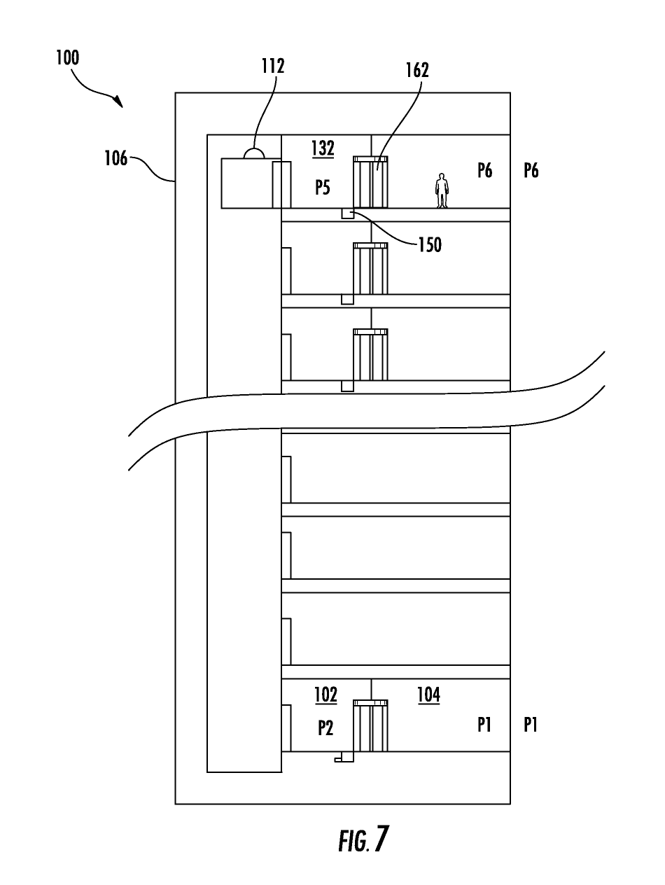

As indicated in FIG. 4, once the passenger is in elevator cab 112, doors 114 and 110 close. Elevator cab 112 ascends, and as it does so, pressurizer 164 transitions the pressure (ΔP) of elevator cab 112 from P2 to P5. Upon arrival at upper lobby 132, doors 114 and 126 open and the passenger can move into upper lobby 132 as shown in FIG. 6. Doors 114 and 126 close and the passenger passes through door 162. In doing so, the passenger passes through a final pressure drop from P5 to P6, which is the ambient pressure at the level of upper lobby 132, as indicated in FIG. 7. In this manner, the passenger is able to make transitions in the pressurized lobbies that provide for comfortable inner ear equalization, and allow for faster elevator cab speeds than in traditional systems. Those skilled in the art having the benefit of this disclosure will readily appreciate how to reverse the process described above with respect to FIGS. 1-7 for descending from an upper level to a lower level. Moreover, while the example above describes moving from the lowest floor in a building to the top floor in the building, those skilled in the art will readily appreciate that the systems and methods described herein can be used to move between any floors in a building, e.g., where pressure is an issue. For example, the processes describe above can be used to move passengers between pressurized lobby 102 and pressurized lobbies 128 or 130 at pressures P3 and P4, respectively.

Those skilled in the art will readily appreciate that while referred to herein as pressurized, lobbies, elevator cabs, and the like referred to herein as pressurized can be pressure controlled or regulated to raise or lower the pressure relative to ambient pressure. Those skilled in the art will also readily appreciate that adjustment to pressure, e.g., in the inner ear, requires time. There should be adequate room in the pressurized lobby for passengers to await the arrival of the elevator cab as their inner ears adjust. For sensitive passengers, they may choose to wait some extra time in the destination lobby for their ears to adjust before passing through the revolving doors. They could also wait extra time in the starting lobby before entering the elevator.

The methods and systems of the present disclosure, as described above and shown in the drawings, provide for elevator pressurization with superior properties including improved passenger inner ear comfort and increased elevator cab speeds. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A method of pressurizing an elevator cab comprising:
pressurizing a lobby to a pressure different from ambient pressure at the elevation of the lobby; and
opening fluid communication between the lobby and an elevator cab.

2. A method as recited in claim 1, wherein pressurizing the lobby includes pressurizing the lobby to a pressure between the ambient pressure at the elevation of the lobby and an ambient pressure at a destination elevation.

3. A method as recited in claim 2, further comprising:
sealing the elevator cab from the lobby; and
pressurizing the elevator cab to a pressure between that of the lobby and the ambient pressure at the destination elevation.

4. A method as recited in claim 3, further comprising:
pressurizing a destination lobby at the destination elevation to a pressure between that of the elevator cab and ambient pressure at the destination elevation;
moving the elevator cab to the destination elevation; and
opening fluid communication between the elevator cab and the destination lobby.

5. A method as recited in claim 4, wherein moving the elevator cab includes moving the elevator cab upward at an ascent rate of greater than or equal to 10 meters per second.

6. A method as recited in claim 4, wherein moving the elevator cab includes moving the elevator cab downward at a descent rate of greater than or equal to 10 meters per second.

7. An elevator pressurization system comprising:
a pressurized lobby sealed from ambient atmospheric pressure; and
a hoistway connected to the pressurized lobby by a hoistway door.

8. A system as recited in claim 7, wherein the pressurized lobby is a first pressurized lobby at a first elevation, wherein the elevator pressurization system further comprises a second pressurized lobby at a second elevation above the first pressurized lobby, wherein the second pressurized lobby is sealed from ambient pressure and is connected to the hoistway by a respective hoistway door.

9. A system as recited in claim 8, further comprising:
an elevator cab supported within the hoistway, wherein the hoistway is in fluid communication with ambient pressure, and wherein the elevator cab includes an elevator cab door which in a closed position seals the elevator cab from ambient pressure, wherein the elevator cab door is configured to cooperate with the hoistway doors to provide access between the pressurized lobbies and the elevator cab.

10. A system as recited in claim 7, further comprising a pressure controller operatively connected to control a pressurizer that is in fluid communication with the pressurized lobby, wherein the pressure controller and pressurizer are configured to regulate pressure within the pressurized lobby.

11. A system as recited in claim 7, wherein the pressurized lobby includes a sealed building access door spaced apart from the hoistway door that provides access to and from the pressurized lobby.

12. A system as recited in claim 11, wherein the building access door is a revolving door.

13. An elevator pressurization system comprising:
a main lobby that is pressure sealed;
a hoistway connected to the main lobby by a hoistway door;
one or more upper lobbies, each at a unique elevation above that of the main lobby, wherein each upper lobby is pressure sealed and is connected to the hoistway by a respective hoistway door; and
an elevator cab supported within the hoistway, wherein the elevator cab is configured to move among the main lobby and the one or more upper lobbies.

14. A system as recited in claim 13, further comprising one or more non-pressurized lobbies connected to the hoistway by respective hoistway doors at elevations between the elevation of the main lobby and the elevation of the lowest one of the one or more upper lobbies.

15. A system as recited in claim 13, further comprising a pressure controller operatively connected to a pressurizer in fluid communication with the main lobby.

16. A system as recited in claim 15, wherein the pressure controller is operatively connected to a respective pressurizer in fluid communication with each respective of the one or more upper lobbies.

17. A system as recited in claim 13, wherein the elevator cab is sealed from the hoistway and further comprising a pressurizer in fluid communication with the elevator cab.

18. A system as recited in claim 17, wherein the pressurizer of the elevator cab is operatively connected to a pressure controller configured to regulate pressure of the elevator cab as it moves within the hoistway.

19. A system as recited in claim 13, further comprising a seal operatively connected to the hoistway to seal between the hoistway and the main lobby and elevator cab.

20. A system as recited in claim 13, further comprising a respective seal operatively connected to the hoistway to seal between the hoistway and each of the one or more upper lobbies and elevator cab.
